(19) United States
(12) Patent Application Publication
(10) Pub. No.: US 2026/0161769 A1
(43) Pub. Date: Jun. 11, 2026

(54) METHOD, APPARATUS, AND PROGRAM FOR GENERATING SECURE COMPUTATION EXECUTION ENVIRONMENT

(71) Applicant: NEC Corporation, Minato-ku, Tokyo (JP)

(72) Inventors: Yoshihiro Kajiki, Tokyo (JP); Naoshi Higuchi, Tokyo (JP)

(73) Assignee: NEC Corporation, Minato-ku, Tokyo (JP)

(21) Appl. No.: 18/704,103

(22) PCT Filed: Nov. 16, 2021
(86) PCT No.: PCT/JP2021/042114

§ 371 Date: Apr. 24, 2024

(51) Int. Cl. G06F 21/53; G06F 21/60

(52) U.S. Cl. CPC G06F 21/53; G06F 21/602; G06F 2221/034

(57) ABSTRACT

Provided is a method for generating a secure computation execution environment from an application and a runtime that are generated from different responsible parties. The method includes: assigning a second application electronic signature to the application and a second runtime electronic signature to the runtime in an encryption file system of the secure computation execution environment and recording the second application electronic signature and the second runtime electronic signature in a trail storage; and assigning an execution environment electronic signature to the secure computation execution environment and recording the execution environment electronic signature in the trail storage.

### TECHNICAL FIELD

The present invention relates to a method, an apparatus, and a program for generating a secure computation execution environment.

### BACKGROUND ART

A technique called secure computation that can compute encrypted data can be roughly classified into three methods. One method is called secret sharing in which data that needs to be kept secret is divided into a plurality of data in accordance with a predetermined rule. Each of a plurality of participants holds part of the plurality of data in a secret sharing manner. Another method uses homomorphic encryption. In this encryption method called homomorphic encryption, it is possible to obtain an encrypted text that indicates a computation result of cleartexts, without decrypting encrypted texts.

The other method is called TEE (Trusted Execution Environment) (for example, see PTL). In TEE, an area “Enclave” protected by an encryption technique is configured on a memory of a device, and confidential information is computed in this area. For example, hardware for TEE is provided as SGX (Software Guard Extensions) in a processor architecture of Intel, is provided as Trust Zone in a processor architecture of ARM (Advanced RISC Machines), and is provided as SEV (Secure Encrypted Virtualization) in a processor architecture of AMD (Advanced Micro Devices). In the present description, unless otherwise described, “secure computation” refers to the secure computation called TEE.

### CITATION LIST

### Patent Literature

PTL 1: International Publication No. 2021/014539

### SUMMARY

### Technical Problem

The disclosure of the above PTL is incorporated herein by reference thereto. The following analysis has been made by the present inventors.

When the secure computation is used for a data platform, unlike a normal secure computation, “1. the provider of secret data”, “2. the provider of the data platform”, and “3. the user of data” are different companies. That is, to conduct a data platform business, these three parties need to prove to each other that the three parties use data while protecting secrecy.

However, in a secure computation execution environment, the original application and runtime are first encrypted such that any other third parties cannot decrypt the encrypted application and runtime and are next stored. Thus, no third parties can verify later that no falsification, etc., have been conducted on the original application and runtime. Herein, the expression “falsification, etc. ,” includes not only malicious rewriting but also a malfunction referred to as a so-called bug that prevents an operation according to the specifications. These characteristics of a secure computation execution environment could become a vulnerability of the secure computation.

Thus, in generating a secure computation execution environment for conducting a data platform business, there is a demand for a mechanism that allows responsible parties of a business to succeed the proof that no falsification, etc., have been conducted on their respective elements in the secure computation execution environment.

In view of the above problem, an object of the present invention is to provide a method, an apparatus, and a program for generating a secure computation execution environment which contributes to allowing responsible parties to succeed the proof that no falsification, etc., have been conducted on their respective elements in the secure computation execution environment.

### Solution to Problem

According to the first aspect of the present invention, there is provided a method for generating a secure computation execution environment from an application and a runtime that are generated from different responsible parties, the method including: assigning a second application electronic signature to the application and a second runtime electronic signature to the runtime in an encryption file system of the secure computation execution environment and recording the second application electronic signature and the second runtime electronic signature in a trail storage; and assigning an execution environment electronic signature to the secure computation execution environment and recording the execution environment electronic signature in the trail storage.

According to the second aspect of the present invention, there is provided an apparartus for generating a secure computation execution environment from an application and a runtime that are generated from different responsible parties, the apparatus including: an element electronic signature part that assigns a second application electronic signature to the application and a second runtime electronic signature to the runtime in an encryption file system of the secure computation execution environment; a container electronic signature part that assigns an execution environment electronic signature to the secure computation execution environment; and a trail storage that stores the second application electronic signature, the second runtime electronic signature, and the execution environment electronic signature.

According to the third aspect of the present invention, there is provided a program for generating a secure computation execution environment from an application and a runtime that are generated from different responsible parties, the program causing a computer to execute: assigning a second application electronic signature to the application and a second runtime electronic signature to the runtime in an encryption file system of the secure computation execution environment and recording the second application electronic signature and the second runtime electronic signature in a trail storage; and assigning an execution environment electronic signature to the secure computation execution environment and recording the execution environment electronic signature in the trail storage. This program can be recorded in a computer-readable storage medium. The storage medium may be a non-transitory storage medium such as a semiconductor memory, a hard disk, a magnetic recording medium, or an optical recording medium. The present invention can be embodied as a computer program product.

### Advantageous Effects of Invention

According to the individual aspects of the present invention, there are provided a method, an apparatus, and a program for generating a secure computation execution environment which contributes to allowing responsible parties to succeed the proof that no falsification, etc., have been conducted on their respective elements in the secure computation execution environment.

### BRIEF DESCRIPTION OF DRAWINGS

FIG. 1 is a drawing conceptually illustrating a method for generating a secure computation execution environment according to a first example embodiment.

FIG. 2 is a drawing conceptually illustrating a method for generating a secure computation execution environment according to a second example embodiment.

FIG. 3 is a drawing illustrating an example of a hardware configuration of a container image generation environment.

FIG. 4 is a drawing schematically illustrating a process for transferring an application from a person responsible for the application to a person responsible for the secure computation execution environment.

FIG. 5 is a drawing schematically illustrating a process for transferring a runtime from a person responsible for the runtime to the person responsible for the secure computation execution environment.

FIG. 6 is a drawing schematically illustrating a process for transferring a secure computation library from a person responsible for the secure computation library to the person responsible for the secure computation execution environment.

FIG. 7 is a drawing illustrating details of a method for assigning an electronic signature to the application in an encryption file system.

FIG. 8 is a drawing illustrating details of a method for assigning an electronic signature to the runtime in the encryption file system.

FIG. 9 is a drawing schematically illustrating a countermeasure taken when the secure computation execution environment is executed.

### EXAMPLE EMBODIMENTS

Hereinafter, example embodiments of the present invention will be described with reference to the drawings. However, the present invention is not limited to the following example embodiments. In addition, in the drawings, the same or equivalent elements are denoted by the same reference characters, as necessary. In addition, the drawings are schematic drawings, and therefore, it should be noted that the sizes, ratios, etc. of the individual elements may differ from their actual sizes, ratios, etc. An element in a drawing may have a portion whose size or ratio differs from that of the portion of the element in a different drawing.

### First Example Embodiment

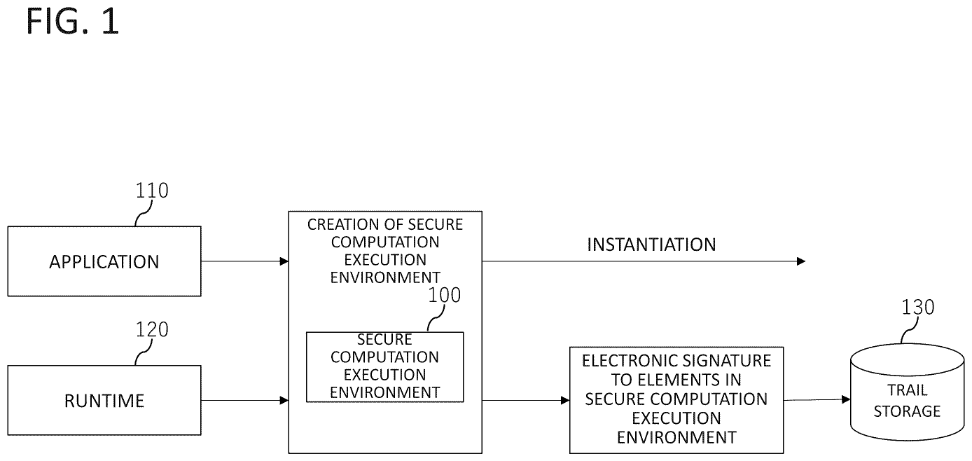

FIG. 1 is a drawing conceptually illustrating a method for generating a secure computation execution environment according to a first example embodiment. As illustrated in FIG. 1, a method for generating a secure computation execution environment 100 according to the first example embodiment is a method for generating a secure computation execution environment from an application 110 and a runtime 120 that are generated by different responsible parties. Since the application 110 and the runtime 120 are generated by different responsible parties, the present example embodiment assumes that the application 110 and the runtime 120 have already been verified by their respective responsible parties. The parties responsible for the application 110 and the runtime 120 will be described in the following example embodiment.

The secure computation execution environment 100 is generated to include at least the application 110 and the runtime 120. The application 110 and the runtime 120 are configured in an area protected by an encryption technique. That is, the application 110 and the runtime 120 are configured in an encryption file system in the secure computation execution environment 100.

When a secure computation is executed, the secure computation execution environment 100 is instantiated and provided to a third party for use. Although the original application 110 and runtime 120 have been verified by their respective responsible parties and have been assigned electronic signatures, this is insufficient for any third part to subsequently verify that falsification, etc., have not been conducted on the application 110 and the runtime 120.

This is because the possibility that falsification, etc., have been conducted on the application 110 and the runtime 120 at the generation stage of the secure computation execution environment 100 cannot be eliminated. Because the application 110 and runtime 120 are configured in an area protected by an encryption technique, when the application 110 and runtime 120 are encrypted, information necessary for the electronic signatures (for example, hash values) change. That is, the electronic signatures assigned by the parties responsible for the original application 110 and runtime 120 are nullified.

Thus, in the method for generating a secure computation execution environment according to the first example embodiment, electronic signatures are assigned to the application 110 and the runtime 120 in the encryption file system of the secure computation execution environment 100, and the electronic signatures are recorded in a trail storage 130. In addition, an electronic signature is assigned to the secure computation execution environment 100, and the electronic signature is recorded in the trail storage 130. It is preferable that the trail storage 130 be a so-called write-once storage configured such that no recorded data can be rewritten.

As described above, the method for generating a secure computation execution environment according to the first example embodiment allows responsible parties to succeed the proof that no falsification, etc., have been conducted on their respective elements in the secure computation execution environment.

### Second Example Embodiment

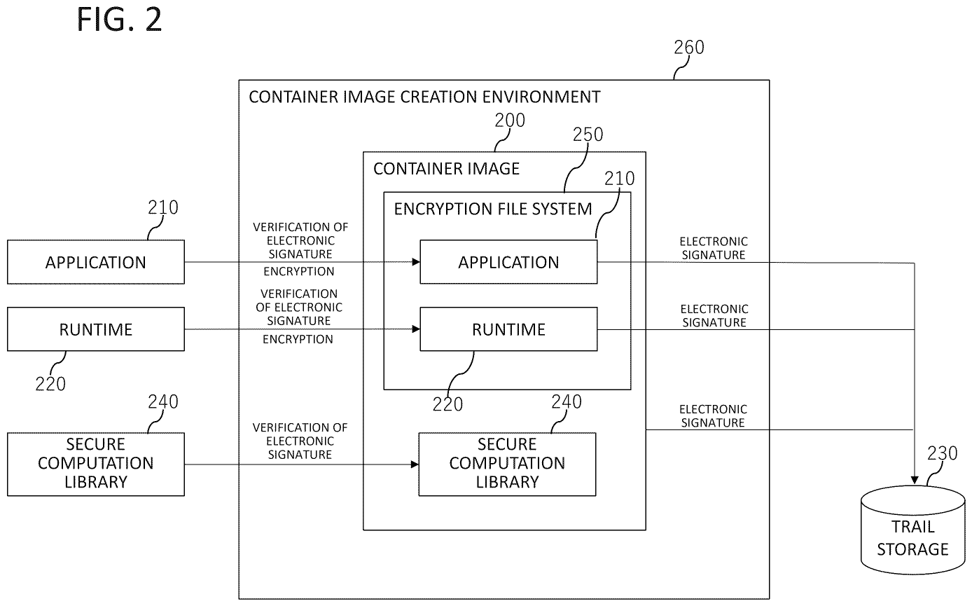

FIG. 2 is a drawing conceptually illustrating a method for generating a secure computation execution environment according to a second example embodiment. The second example embodiment is a mode that is closer to an actual application than the first example embodiment. As illustrated in FIG. 2, the method for generating a secure computation execution environment according to the second example embodiment is a method for generating a secure computation execution environment from an application 210 and a runtime 220 that are generated by different responsible parties. However, in this method, the secure computation execution environment also includes a secure computation library 240, which is generated by still another responsible party. The secure computation execution environment according to the second example embodiment will be described as a container image 200 as a specific example.

The application 210 is a program for executing a secure computation by using a secure computation execution environment. The application 210 is generated with, for example, the responsibility of a user using the secure computation execution environment. The runtime 220 is a library for the application 210 to execute the secure computation by using the secure computation execution environment. The runtime 220 is generated with the responsibility of a business operator providing the user with the secure computation execution environment, for example. Alternatively, the runtime 220 generated by an outside business operator may be used. The application 210 and the runtime 220 are elements that are made secret in the secure computation environment. The application 210 and the runtime 220 are first encrypted by an encryption file system 250 in the container image 200 and are next stored.

The secure computation library 240 is, for example, a low-level library for the application 210 and the runtime 220 to use the secure computation execution environment, and is an OS (Operating System) or a manager for operating the secure computation execution environment. The secure computation execution environment is controlled by a special command group, and the secure computation library 240 is generally used such that the application 210 and the runtime 220 can be crated easily. The secure computation library 240 is stored in a general environment, which is not the encryption file system 250 in the container image 200.

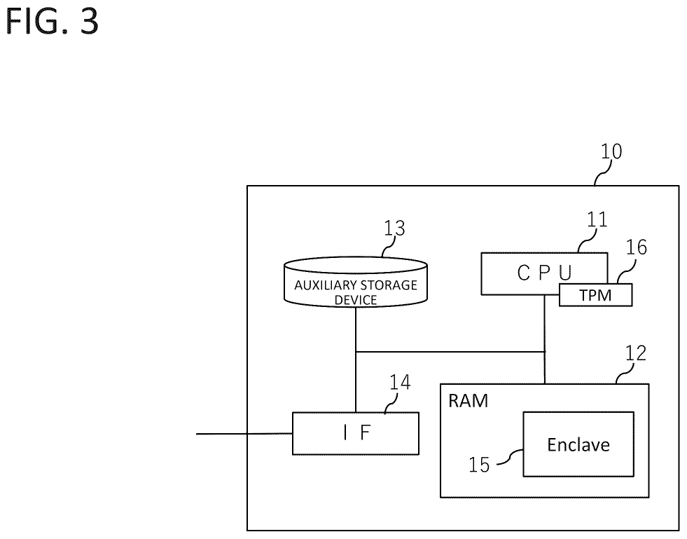

FIG. 3 is a drawing illustrating an example of a hardware configuration of a container image generation environment. As illustrated in FIG. 2, the container image 200, which is a substantial element of the secure computation execution environment, is generated in a container image generation environment 260 and is assigned an electronic signature. The example of the hardware configuration illustrated in FIG. 3 is a specific example of the container image generation environment 260 suitable for this purpose.

A hardware configuration 10 illustrated in FIG. 3 is typically a computer (an electronic computer), and it is preferable that the hardware configuration 10 itself be a secure computation execution environment. That is, the hardware configuration 10 is a computer for generating a secure computation execution environment, and is configured such that the computer itself for this purpose also serves as another secure computation execution environment.

As illustrated in FIG. 3, the hardware configuration 10 includes, for example, a CPU (Central Processing Unit) 11, a RAM (Random Access Memory) 12, an auxiliary storage device 13, and an IF (Interface) part 14, which are connected to one another via an internal bus.

The CPU 11 executes individual commands included in programs executed by the CPU 11. The RAM 12 is, for example, a main storage device, and temporarily stores various kinds of programs executed by the CPU 11 and data processed by the CPU 11.

The RAM 12 includes an Enclave area 15 protected by an encryption technique so as to realize a secure computation execution environment. While there are various kinds of methods, the Enclave area 15 may be an area generated by an encryption technique in accordance with commands from the CPU 11, for example. The communication between the CPU 11 and the Enclave area 15 is also protected by an encryption technique, and the CPU 11 and the Enclave area 15 realize a secure computation execution environment.

In addition, the hardware configuration 10 includes a TPM (Trusted Platform Module) 16. Various kinds of methods may be used for the TPM 16. For example, the TPM 16 may be implemented as a dedicated chip or as a firmware executed in a security area. The functions of the TPM 16 include execution of encryption/decryption, generation of a key pair, computation of hash values, and generation and verification of electronic signatures. With this TPM 16, the hardware configuration 10 can execute various operations, such as addition of electronic signatures according to the present example embodiment, in the secure computation execution environment.

The auxiliary storage device 13 is, for example, an HDD (Hard Disk Drive), and can store, for example, programs executed by the CPU 11 and data processed by the CPU 11 for the medium to long term. The auxiliary storage device 13 adopts an encryption file system, to store programs and secret data executed in secure computation execution environment. Various kinds of programs can be provided as program products recorded in a non-transitory computer-readable storage medium.

The IF part 14 provides an interface relating to the input and output of the hardware configuration 10.

Hereinafter, a method for generating a secure computation execution environment by using the container image generation environment 260 that adopts the above-described hardware configuration 10 will be described in detail.

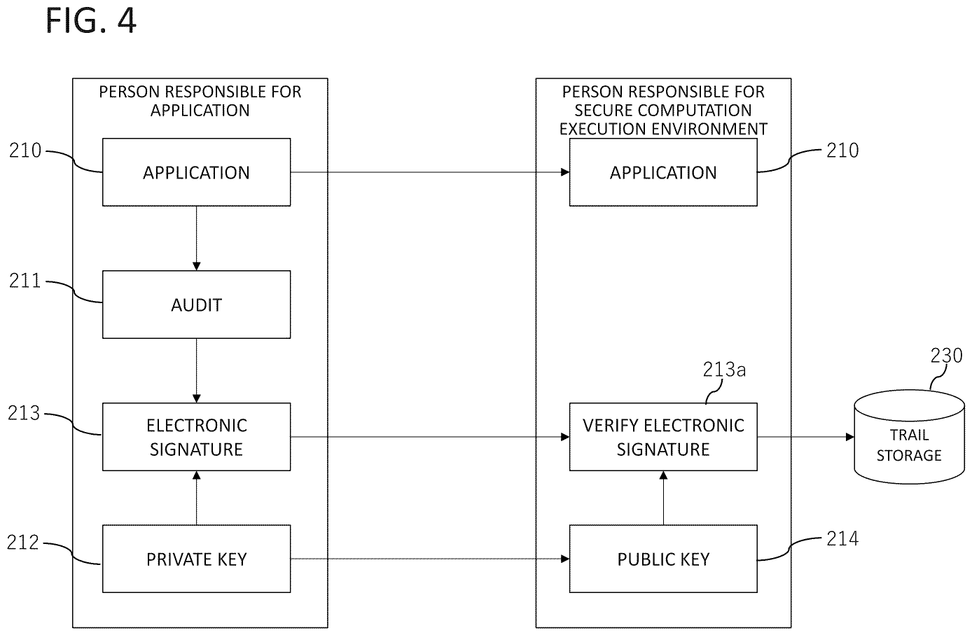

FIGS. 4 to 6 are drawings schematically illustrating processes of transferring the application, the runtime, and the secure computation library from persons responsible for their respective elements to a person responsible for the secure computation execution environment.

As illustrated in FIG. 4, a person responsible for the application 210 conducts an audit 211 on the application 210, and assigns an electronic signature 213 by using a private key 212 of the person responsible for the application 210. To distinguish this electronic signature 213 assigned to the application 210 by using private key 212 of the person responsible for the application 210 from another electronic signature, which will be described below, the electronic signature 213 will be referred to as a first application electronic signature, as needed.

After receiving the application 210, the person responsible for the secure computation execution environment conducts a verification 213a on the electronic signature 213 by using a public key 214 of the person responsible for the application 210, confirms that the application 210 has been properly audited, and records the electronic signature 213 in a trail storage 230.

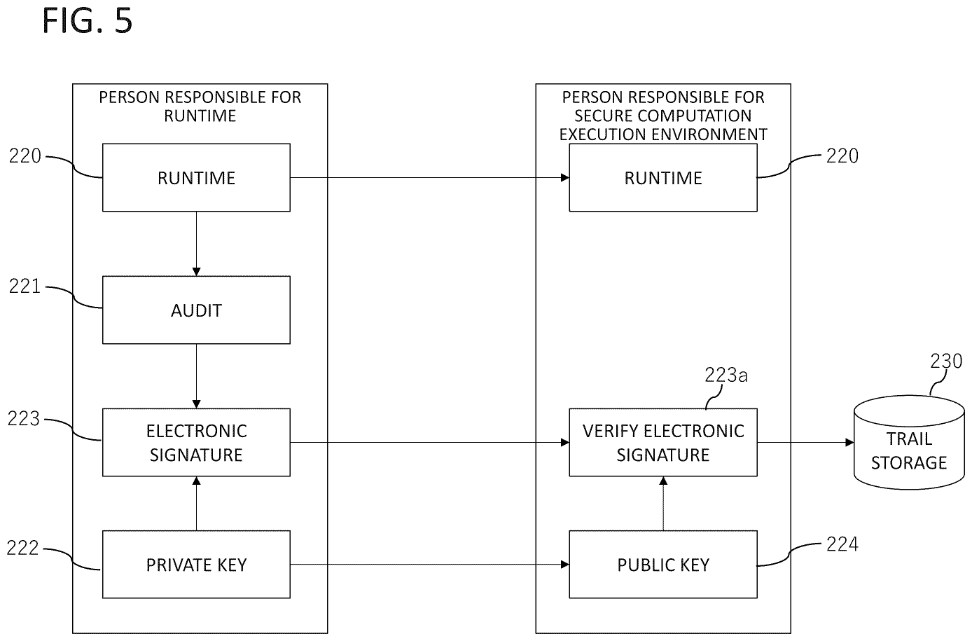

As illustrated in FIG. 5, a person responsible for the runtime 220 conducts an audit 221 on the runtime 220, and assigns an electronic signature 223 by using a private key 222 of the person responsible for the runtime 220. To distinguish this electronic signature 223 assigned to the runtime 220 by using the private key 222 of the person responsible for the runtime 220 from another electronic signature, which will be described below, the electronic signature 223 will be referred to as a first runtime electronic signature, as needed.

After receiving the runtime 220, the person responsible for the secure computation execution environment conducts a verification 223a on the electronic signature 223 by using a public key 224 of the person responsible for the runtime 220, confirms that the runtime 220 has been properly audited, and records the electronic signature 223 in the trail storage 230.

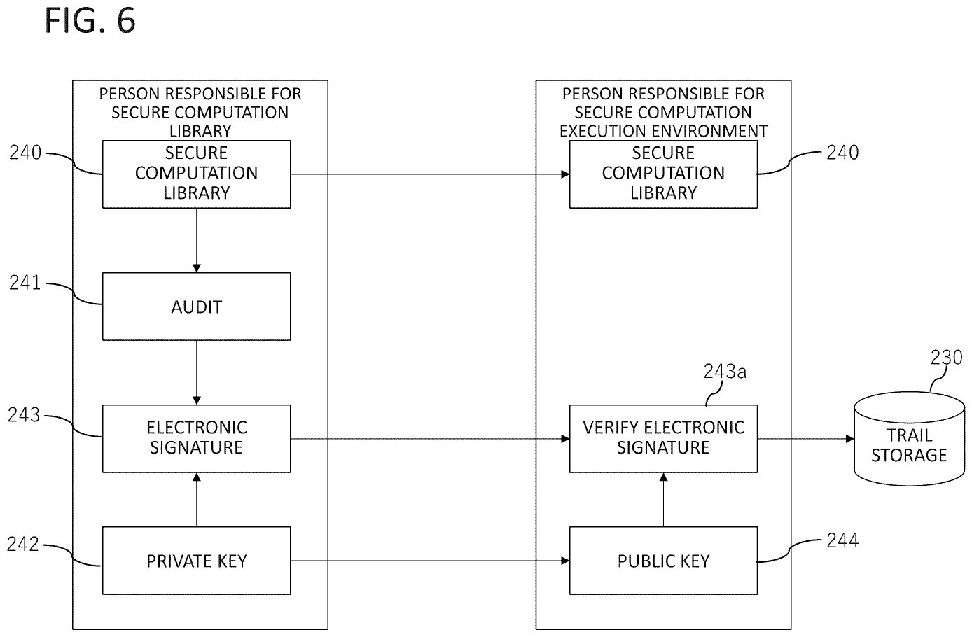

As illustrated in FIG. 6, a person responsible for the secure computation library 240 conducts an audit 241 on the secure computation library 240, and assigns an electronic signature 243 by using a private key 242 of the person responsible for the secure computation library 240. After receiving the secure computation library 240, the person responsible for the secure computation execution environment conducts a verification 243a on the electronic signature 243 by using a public key 244 of the person responsible for the secure computation library 240, confirms that the secure computation library 240 has been properly audited, and records the electronic signature 243 in the trail storage 230.

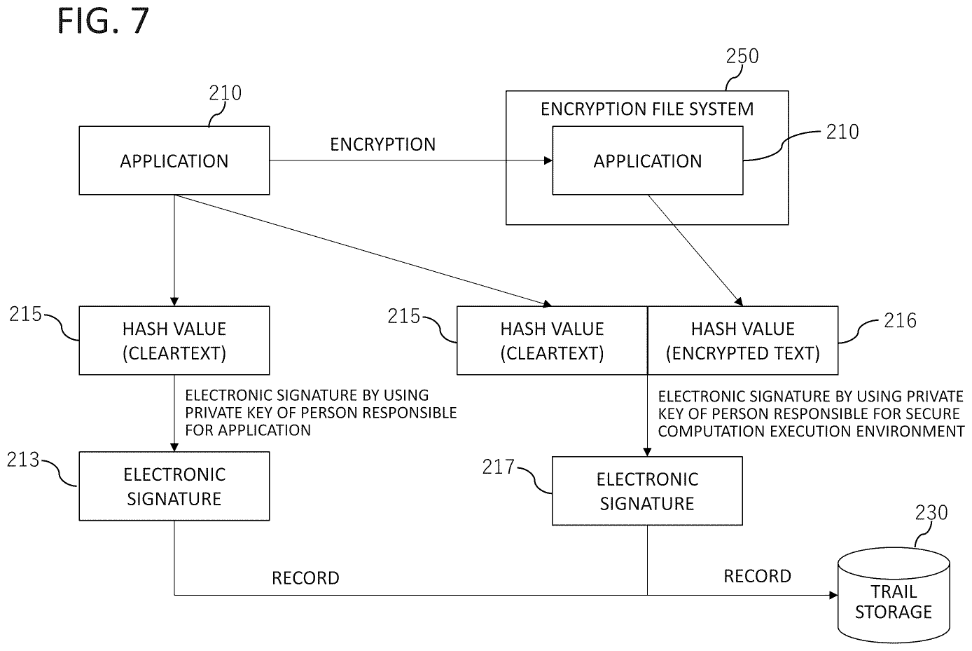

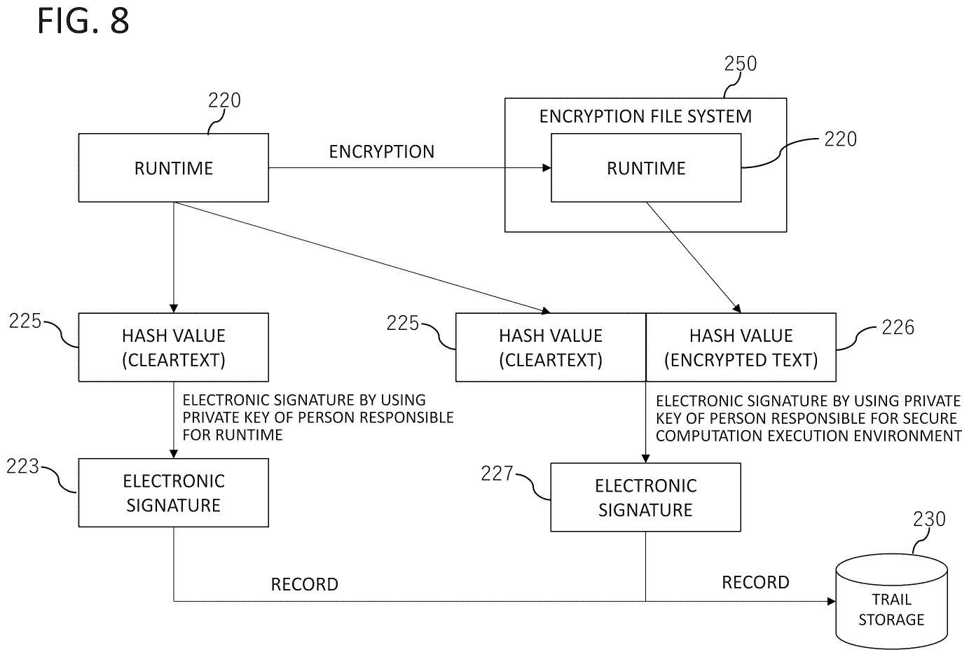

FIG. 7 is a drawing illustrating details of a method for assigning an electronic signature to the application in the encryption file system. FIG. 8 is a drawing illustrating details of a method for assigning an electronic signature to the runtime in the encryption file system.

As illustrated in FIG. 7, the electronic signature 213 (the first application electronic signature) is assigned to the application 210 by using the private key of the person responsible for the application 210. The electronic signature 213 (the first application electronic signature) is obtained by encrypting a hash value 215 of the application 210 by using the private key of the person responsible for the application 210.

The application 210 is stored in the encryption file system 250 in the process of generating the secure computation execution environment. In addition, an electronic signature 217 (a second application electronic signature) is assigned by using the private key of the person responsible for the secure computation execution environment. The electronic signature 217 (the second application electronic signature) is obtained by coupling the hash value 215 of the application 210, the hash value 215 as being a cleartext obtained before the application 210 is encrypted, and a hash value 216 as being an encrypted text obtained after the application 210 is encrypted in the encryption file system 250 and by encrypting the resultant hash value by using the private key of the person responsible for the secure computation execution environment.

The electronic signature 217 (the second application electronic signature) can be generated in the secure computation execution environment by using the function of the above-described TPM 16. That is, the container image generation environment 260 itself is another secure computation execution environment, and the function of the TPM 16 enables the generation of the electronic signature 217 (the second application electronic signature) by using the private key protected in the secure computation execution environment. In this way, it is possible to realize a method for generating a secure computation execution environment having less vulnerability while reducing the possibility that the person responsible for the secure computation execution environment conducts falsification, etc.

As illustrated in FIG. 8, the electronic signature 223 (the first runtime electronic signature) is assigned to the runtime 220 by using the private key of the person responsible for the runtime 220. The electronic signature 223 (the first runtime electronic signature) is obtained by encrypting a hash value 225 of the runtime 220 by using the private key of the person responsible for the runtime 220.

The runtime 220 is stored in the encryption file system 250 in the process of generating the secure computation execution environment. In addition, an electronic signature 227 (a second runtime electronic signature) is assigned by using the private key of the person responsible for the secure computation execution environment. The electronic signature 227 (the second runtime electronic signature) is obtained by coupling the hash value 225 of the runtime 220, the hash value 225 as being a cleartext obtained before the runtime 220 is encrypted, and a hash value 226 as being an encrypted text obtained after the runtime 220 is encrypted in the encryption file system 250 and by encrypting the resultant hash value by using the private key of the person responsible for the secure computation execution environment.

The electronic signature 227 (the second runtime electronic signature) can be generated in the secure computation execution environment by using the function of the above-described TPM 16. That is, the container image generation environment 260 itself is another secure computation execution environment, and the function of the TPM 16 enables the generation of the electronic signature 227 (the second runtime electronic signature) by using the private key protected in the secure computation execution environment.

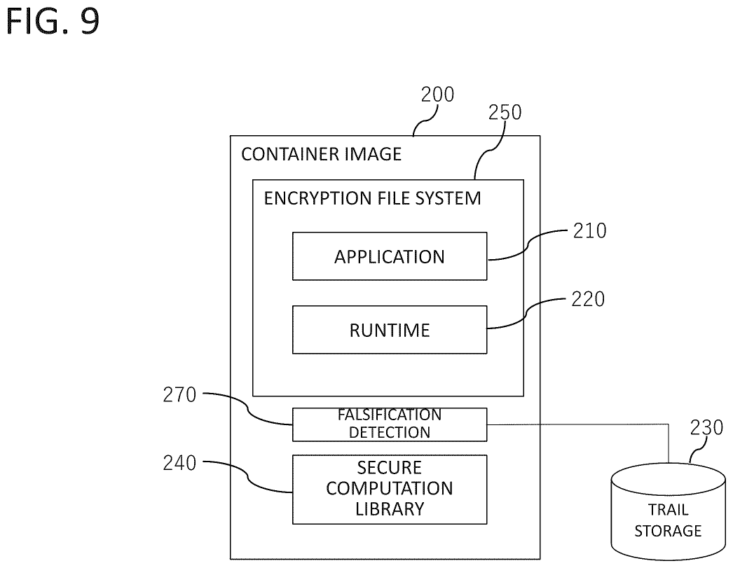

FIG. 9 is a drawing schematically illustrating a countermeasure taken when the secure computation execution environment is executed. Even when a secure computation execution environment is generated with the above-described countermeasure to reduce the possibility that falsification, etc., are included, there is still a possibility that falsification, etc., are included at the time of the execution of the secure computation execution environment.

Thus, as illustrated in FIG. 9, a falsification detection system 270 is installed in the container image 200, and an integrity check is conducted regularly with the electronic signatures in the trail storage 230.

The above example embodiments can partially or entirely be described, but not limited to, as the following notes.

### [Note 1]

A method for generating a secure computation execution environment from an application and a runtime that are generated from different responsible parties, the method including:
assigning a second application electronic signature to the application and a second runtime electronic signature to the runtime in an encryption file system of the secure computation execution environment and recording the second application electronic signature and the second runtime electronic signature in a trail storage; and
assigning an execution environment electronic signature to the secure computation execution environment and recording the execution environment electronic signature in the trail storage.

### [Note 2]

The method for generating the secure computation execution environment according to note 1;
wherein the second application electronic signature is obtained by coupling information about the application obtained before the secure computation execution environment is generated and information about the application in the encryption file system of the secure computation execution environment and by assigning an electronic signature to the resultant information; and
wherein the second runtime electronic signature is obtained by coupling information about the runtime obtained before the secure computation execution environment is generated and information about the runtime in the encryption file system of the secure computation execution environment and by assigning an electronic signature to the resultant information.

### [Note 3]

The method for generating the secure computation execution environment according to note 2;
wherein after a person responsible for the application conducts an audit, a first application electronic signature is assigned by using a private key of the person responsible for the application;
wherein after a person responsible for the runtime conducts an audit, a first runtime electronic signature is assigned by using a private key of the person responsible for the runtime;
wherein the first application electronic signature is verified by using a public key of the person responsible for the application;

wherein the first runtime electronic signature is verified by using a public key of the person responsible for the runtime; and
wherein after the verifications, the secure computation execution environment is generated from the application and the runtime.

### [Note 4]

The method for generating the secure computation execution environment according to note 3;
wherein the first application electronic signature is obtained by assigning an electronic signature to a hash value of the application obtained after the person responsible for the application conducts the audit by using the private key of the person responsible for the application;
wherein the second application electronic signature is obtained by coupling a hash value of the application obtained after the person responsible for the application conducts the audit and a hash value of the application in the encryption file system of the secure computation execution environment and by assigning an electronic signature to the resultant hash value by using a private key of a person responsible for the secure computation execution environment;
wherein the first runtime electronic signature is obtained by assigning an electronic signature to a hash value of the runtime obtained after the person responsible for the runtime conducts the audit by using the private key of the person responsible for the runtime; and
wherein the second runtime electronic signature is obtained by coupling a hash value of the runtime obtained after the person responsible for the runtime conducts the audit and a hash value of the runtime in the encryption file system of the secure computation execution environment and by assigning an electronic signature to the resultant hash by using the private key of the person responsible for the secure computation execution environment.

### [Note 5]

The method for generating the secure computation execution environment according to any one of notes 1 to 4, the method including;
generating the secure computation execution environment from the application and the runtime by using another secure computation execution environment; and
generating each of the second application electronic signature and the second runtime electronic signature by using a private key protected in the another secure computation execution environment.

### [Note 6]

The method for generating the secure computation execution environment according to any one of notes 1 to 5, the secure computation execution environment additionally including a secure computation library generated by still another responsible party and the method including:
assigning an execution environment electronic signature to the secure computation execution environment including the secure computation library and recording the execution environment electronic signature in the trail storage.

### [Note 7]

The method for generating the secure computation execution environment according to any one of notes 1 to 6; wherein the trail storage is a write-once storage.

### [Note 8]

An apparartus for generating a secure computation execution environment from an application and a runtime that are generated from different responsible parties, the apparatus including:
an element electronic signature part that assigns a second application electronic signature to the application and a second runtime electronic signature to the runtime in an encryption file system of the secure computation execution environment;
a container electronic signature part that assigns an execution environment electronic signature to the secure computation execution environment; and
a trail storage that stores the second application electronic signature, the second runtime electronic signature, and the execution environment electronic signature.

### [Note 9]

The apparatus for generating the secure computation execution environment according to note 8, the apparatus including;
another secure computation execution environment for generating a secure computation execution environment from the application and the runtime; and
a private key protected in the another secure computation execution environment;
wherein the element electronic signature part generates each of the second application electronic signature and the second runtime electronic signature by using a private key protected in the another secure computation execution environment.

### [Note 10]

A program for generating a secure computation execution environment from an application and a runtime that are generated from different responsible parties, the program causing a computer to execute:
assigning a second application electronic signature to the application and a second runtime electronic signature to the runtime in an encryption file system of the secure computation execution environment and recording the second application electronic signature and the second runtime electronic signature in a trail storage; and
assigning an execution environment electronic signature to the secure computation execution environment and recording the execution environment electronic signature in the trail storage.

The disclosure of the above PTL is incorporated herein by reference thereto. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been concretely disclosed. In addition, as needed and based on the gist of the present invention, partial or entire use of the individual disclosed matters in the above literature that has been referred to in combination with what is disclosed in the present application should be deemed to be included in what is disclosed in the present application, as a part of the disclosure of the present invention.

### REFERENCE SIGNS LIST

100 Secure computation execution environment
110, 210 Application
120, 220 Runtime
130, 230 Trail storage
200 Container image
240 Secure computation library
250 Encryption file system
260 Container image generation environment
211, 221, 241 Audit
212, 222, 242 Private key
213, 217, 223, 227, 243 Electronic signature
213a, 223a, 243a Verification of electronic signature
214, 224, 244 Public key
215, 216, 225, 226 Hash value
270 Falsification detection system
10 Hardware configuration
11 CPU
12 RAM
13 Auxiliary storage device
14 IF part
15 Enclave area
16 TPM

What is claimed is:

1. A method for generating a secure computation execution environment from an application and a runtime that are generated from different responsible parties, the method comprising:
assigning a second application electronic signature to the application and a second runtime electronic signature to the runtime in an encryption file system of the secure computation execution environment and recording the second application electronic signature and the second runtime electronic signature in a trail storage; and
assigning an execution environment electronic signature to the secure computation execution environment and recording the execution environment electronic signature in the trail storage.

2. The method for generating the secure computation execution environment according to claim 1;
wherein the second application electronic signature is obtained by coupling information about the application obtained before the secure computation execution environment is generated and information about the application in the encryption file system of the secure computation execution environment and by assigning an electronic signature to the resultant information; and
wherein the second runtime electronic signature is obtained by coupling information about the runtime obtained before the secure computation execution environment is generated and information about the runtime in the encryption file system of the secure computation execution environment and by assigning an electronic signature to the resultant information.

3. The method for generating the secure computation execution environment according to claim 2;
wherein after a person responsible for the application conducts an audit, a first application electronic signature is assigned by using a private key of the person responsible for the application;
wherein after a person responsible for the runtime conducts an audit, a first runtime electronic signature is assigned by using a private key of the person responsible for the runtime;
wherein the first application electronic signature is verified by using a public key of the person responsible for the application;
wherein the first runtime electronic signature is verified by using a public key of the person responsible for the runtime; and
wherein after the verifications, the secure computation execution environment is generated from the application and the runtime.

4. The method for generating the secure computation execution environment according to claim 3;
wherein the first application electronic signature is obtained by assigning an electronic signature to a hash value of the application obtained after the person responsible for the application conducts the audit by using the private key of the person responsible for the application;
wherein the second application electronic signature is obtained by coupling a hash value of the application obtained after the person responsible for the application conducts the audit and a hash value of the application in the encryption file system of the secure computation execution environment and by assigning an electronic signature to the resultant hash value by using a private key of a person responsible for the secure computation execution environment;
wherein the first runtime electronic signature is obtained by assigning an electronic signature to a hash value of the runtime obtained after the person responsible for the runtime conducts the audit by using the private key of the person responsible for the runtime; and
wherein the second runtime electronic signature is obtained by coupling a hash value of the runtime obtained after the person responsible for the runtime conducts the audit and a hash value of the runtime in the encryption file system of the secure computation execution environment and by assigning an electronic signature to the resultant hash by using the private key of the person responsible for the secure computation execution environment.

5. The method for generating the secure computation execution environment according to claim 1, the method comprising;
generating the secure computation execution environment from the application and the runtime by using another secure computation execution environment; and
generating each of the second application electronic signature and the second runtime electronic signature by using a private key protected in the another secure computation execution environment.

6. The method for generating the secure computation execution environment according to claim 1, the secure computation execution environment additionally including a secure computation library generated by still another responsible party and the method comprising:
assigning an execution environment electronic signature to the secure computation execution environment including the secure computation library and recording the execution environment electronic signature in the trail storage.

7. The method for generating the secure computation execution environment according to claim 1; wherein the trail storage is a write-once storage.

8. An apparartus for generating a secure computation execution environment from an application and a runtime that are generated from different responsible parties, the apparatus comprising:
an element electronic signature part that assigns a second application electronic signature to the application and a second runtime electronic signature to the runtime in an encryption file system of the secure computation execution environment;
a container electronic signature part that assigns an execution environment electronic signature to the secure computation execution environment; and
a trail storage that stores the second application electronic signature, the second runtime electronic signature, and the execution environment electronic signature.

9. The apparatus for generating the secure computation execution environment according to claim 8, the apparatus comprising;
another secure computation execution environment for generating a secure computation execution environment from the application and the runtime; and
a private key protected in the another secure computation execution environment;
wherein the element electronic signature part generates each of the second application electronic signature and the second runtime electronic signature by using a private key protected in the another secure computation execution environment.

10. A non-transitory computer readable medium storing a program for generating a secure computation execution environment from an application and a runtime that are generated from different responsible parties, the program causing a computer to execute:
assigning a second application electronic signature to the application and a second runtime electronic signature to the runtime in an encryption file system of the secure computation execution environment and recording the second application electronic signature and the second runtime electronic signature in a trail storage; and
assigning an execution environment electronic signature to the secure computation execution environment and recording the execution environment electronic signature in the trail storage.

11. The apparatus for generating the secure computation execution environment according to claim 8;
wherein the second application electronic signature is obtained by coupling information about the application obtained before the secure computation execution environment is generated and information about the application in the encryption file system of the secure computation execution environment and by assigning an electronic signature to the resultant information; and
wherein the second runtime electronic signature is obtained by coupling information about the runtime obtained before the secure computation execution environment is generated and information about the runtime in the encryption file system of the secure computation execution environment and by assigning an electronic signature to the resultant information.

12. The apparatus for generating the secure computation execution environment according to claim 11;
wherein after a person responsible for the application conducts an audit, a first application electronic signature is assigned by using a private key of the person responsible for the application;
wherein after a person responsible for the runtime conducts an audit, a first runtime electronic signature is assigned by using a private key of the person responsible for the runtime;
wherein the first application electronic signature is verified by using a public key of the person responsible for the application;
wherein the first runtime electronic signature is verified by using a public key of the person responsible for the runtime; and
wherein after the verifications, the secure computation execution environment is generated from the application and the runtime.

13. The apparatus for generating the secure computation execution environment according to claim 12;
wherein the first application electronic signature is obtained by assigning an electronic signature to a hash value of the application obtained after the person responsible for the application conducts the audit by using the private key of the person responsible for the application;
wherein the second application electronic signature is obtained by coupling a hash value of the application obtained after the person responsible for the application conducts the audit and a hash value of the application in the encryption file system of the secure computation execution environment and by assigning an electronic signature to the resultant hash value by using a private key of a person responsible for the secure computation execution environment;
wherein the first runtime electronic signature is obtained by assigning an electronic signature to a hash value of the runtime obtained after the person responsible for the runtime conducts the audit by using the private key of the person responsible for the runtime; and
wherein the second runtime electronic signature is obtained by coupling a hash value of the runtime obtained after the person responsible for the runtime conducts the audit and a hash value of the runtime in the encryption file system of the secure computation execution environment and by assigning an electronic signature to the resultant hash by using the private key of the person responsible for the secure computation execution environment.

14. The apparatus for generating the secure computation execution environment according to claim 8; wherein the trail storage is a write-once storage.

15. The non-transitory computer readable medium storing the program according to claim 10;
wherein the second application electronic signature is obtained by coupling information about the application obtained before the secure computation execution environment is generated and information about the application in the encryption file system of the secure computation execution environment and by assigning an electronic signature to the resultant information; and
wherein the second runtime electronic signature is obtained by coupling information about the runtime obtained before the secure computation execution environment is generated and information about the runtime in the encryption file system of the secure computation execution environment and by assigning an electronic signature to the resultant information.

16. The non-transitory computer readable medium storing the program according to claim 15;
wherein after a person responsible for the application conducts an audit, a first application electronic signature is assigned by using a private key of the person responsible for the application;
wherein after a person responsible for the runtime conducts an audit, a first runtime electronic signature is assigned by using a private key of the person responsible for the runtime;
wherein the first application electronic signature is verified by using a public key of the person responsible for the application;
wherein the first runtime electronic signature is verified by using a public key of the person responsible for the runtime; and
wherein after the verifications, the secure computation execution environment is generated from the application and the runtime.

17. The non-transitory computer readable medium storing the program according to claim 16;
wherein the first application electronic signature is obtained by assigning an electronic signature to a hash value of the application obtained after the person responsible for the application conducts the audit by using the private key of the person responsible for the application;
wherein the second application electronic signature is obtained by coupling a hash value of the application obtained after the person responsible for the application conducts the audit and a hash value of the application in the encryption file system of the secure computation execution environment and by assigning an electronic signature to the resultant hash value by using a private key of a person responsible for the secure computation execution environment;
wherein the first runtime electronic signature is obtained by assigning an electronic signature to a hash value of the runtime obtained after the person responsible for the runtime conducts the audit by using the private key of the person responsible for the runtime; and
wherein the second runtime electronic signature is obtained by coupling a hash value of the runtime obtained after the person responsible for the runtime conducts the audit and a hash value of the runtime in the encryption file system of the secure computation execution environment and by assigning an electronic signature to the resultant hash by using the private key of the person responsible for the secure computation execution environment.

18. The non-transitory computer readable medium storing the program according to claim 10, the program causing a computer to execute:
generating the secure computation execution environment from the application and the runtime by using another secure computation execution environment; and
generating each of the second application electronic signature and the second runtime electronic signature by using a private key protected in the another secure computation execution environment.

19. The non-transitory computer readable medium storing the program according to claim 10, the secure computation execution environment additionally including a secure computation library generated by still another responsible party and the program causing a computer to execute:
assigning an execution environment electronic signature to the secure computation execution environment including the secure computation library and recording the execution environment electronic signature in the trail storage.

20. The non-transitory computer readable medium storing the program according to claim 10; wherein the trail storage is a write-once storage.
